(19) United States
(12) Patent Application Publication
(10) Pub. No.: US 2026/0153308 A1
(43) Pub. Date: Jun. 4, 2026

(54) DeepWind: Artificial Intelligence Device and Methods for Recognizing Wind Along a Projectile Trajectory Path using String

(71) Applicants: Kendyl A Roman, SUNNYVALE, CA (US); John Livacich, LOS GATOS, CA (US)

(72) Inventors: Kendyl A Roman, SUNNYVALE, CA (US); John Livacich, LOS GATOS, CA (US)

(73) Assignee: Evrio, Inc., SANTA CLARA, CA (US)

(21) Appl. No.: 18/431,980

(22) Filed: Feb. 4, 2024

(51) Int. Cl. F41G 3/08; G01P 5/00

(52) U.S. Cl. CPC F41G 3/08; G01P 5/001

(57) ABSTRACT

An artificial intelligence (AI) device and methods for recognizing wind along a projectile trajectory path by recognizing winds effect on a string. The string is the teacher. Embodiments include a deep learning model implemented as convolutional neural networks to detect a string and identify wind direction and speed along at least a segment of the projectile trajectory path to a target. The AI is trained with images (photos and or video) and/or audio recordings of strings as well as wind direction and speed at number of points along the projectile trajectory path. One embodiment supports the string with a rod having a predetermined pattern of dark bands and light bands. The trained, portable AI device recognizes a string in real time. When optimum wind speed is sustained for brief time, a green light is illuminated. An aiming point is adjusted for range and crosswind.

### BACKGROUND—FIELD OF THE INVENTION

The present invention relates to detection of wind, in particular the detection of wind that affects a projectile trajectory path to a desired target. The present invention relates to the use of artificial intelligence (AI) to observe on object, such a string supported by flexible rods, positioned along at least a segment of the projectile trajectory path, and to recognize the wind effect on the object. The AI is embedded in an AI device having an image or audio sensor for training the AI. The present invention also relates to devices such as smart rifle scope, handheld rangefinders, smart binoculars, smart phones and tablets that comprise a trained AI used to select a target, and then the trained AI presents information regarding the predicted effect of wind on the projectile trajectory path and provides an aiming point and an indication that there is a period of sustained consistent wind.

### BACKGROUND—DESCRIPTION OF PRIOR ART

### Firing Device and Projectiles

Firing devices such as bows, crossbows, rifles, pistols, other guns, and artillery have been used for sport, hunting, law enforcement, and military. Each firing device is used to launch a projectile such as an arrow, dart, bullet, ball, or explosive shell along a projectile trajectory.

FIG. 1 shows a user (in this case, an archer) 100 with a bow 102 with a bow sight 110 and an arrow 104. The bow sight 110 comprises pins adjusted e.g., for twenty yards, forty yards, and sixty yards, namely a twenty-yard pin, a forty-yard pin, and a sixty-yard pin, respectively.

FIG. 2 shows a rifle with a rifle scope 302. Rifle balls and/or bullets are typically shot from a gun using the arms to aim and sight by aligning the gun sights or gun scope reticle with the target.

Artillery balls and shells are typically shot by adjusting the aim mechanically.

Arrows, spears, balls, bullets, and shells when fired follow a ballistic trajectory. Such projectiles, which are not self-propelled, move through air according to a generally parabolic curve due primarily to the effects of gravity.

The actual projectile trajectory path is not a perfect parabola in a plane due to many factors, such as air drag and lift, crosswind, head wind, tail wind, spin drift, and Coriolis effect. Each bullet type has a different weight and shape which affects the ballistic trajectory. Ballistic coefficients can be determined of each bullet. Drag is affected by environmental factors such as temperature, humidity, barometric pressure.

The Army Research Laboratory publishedWind Drift of Projectiles: A Ballistics Tutorial, ARL-TR-1124, by Herbert A. Leupold, October 1996.

Let's Code Physics, Projectile Motion 12—Drag and Wind, https://youtu.be/lGg7wNf1w-k, teaches programming models for drag and wind on projectiles. Source code is available at the letscodephysics Google Site (Let's Code Physics/projectile motion/12 3D projectile motion—football field goal—w wind.py).

Rifle and bow scopes conventionally have been fitted with reticles of different forms. Some have horizontal and vertical cross hairs. These reticles are fixed in that the display does not change based on range information. Also, these reticles indicate the approximate hold-over position in that they are positioned under the center of the scope, i.e., below where the cross hairs intersect. They are not necessarily precise, for example, for a specific bow and archer or for a specific rifle and cartridge but are approximation for the general case.

### Smart Devices

Hunters and other firearm and bow users commonly utilize handheld rangefinders (see device 6 in FIG. 1) to determine ranges to targets. Generally, handheld rangefinders utilize lasers to acquire ranges for display to a user. Utilizing the displayed ranges, the user makes sighting corrections to facilitate accurate shooting. Handheld rangefinders, telescope sights, and other optical devices typically comprise a laser range sensor and an inclinometer.

Our U.S. Pat. No. 9,057,587, issued Jun. 16, 2015, and U.S. Pat. No. 9,068,795, issued Jun. 30, 2015, both included by reference, disclose and claim a smart rangefinders which: a) provide an aiming point; b) provide a digital rangefinder having a video camera and high-resolution digital display; and c) displays an aiming point, corrected for range and wind effect anywhere on the high-resolution display.

These patents also disclose the use of a smart phone, such as an iPhone, as a display for a digital rangefinder.

### Artificial Intelligence Advances

The U.S. Defense Advanced Research Projects Agency (DARPA) funded the Cognitive Assistant that Learns and Organizes (CALO) project for five years from 2003 to 2008. CALO brought together over 300 researchers from 25 of the top university and commercial research institutions. Software and documentation are available on the PAL website: https://pal.sri.com.

Several AI technologies have spun off from the CALO work, including, for example, Apple's Siri speech recognition, analysis, and speech synthesis.

In October 2006, Intel released version 2 of Open Source Computer Vision Library (OpenCV 2). In August 2012, opencv. org began providing support for OpenCV. Applications for OpenCV include object detection and facial recognition systems. Open source code repositories are available on github.com e.g., opencv/opencv.

In 2013, NVIDIA introduced the Tegra 4. With NVIDIA GPU-accelerated deep learning frameworks, researchers and data scientists can significantly speed up deep learning training that could otherwise take days and weeks to just hours and days. When models are ready for deployment, developers can rely on GPU-accelerated inference platforms for the cloud, embedded device, or self-driving cars, to deliver high-performance, low-latency inference for the most computationally-intensive deep neural networks. https://www.nvidia.com/en-us/glossary/deep-learning/.

In June 2014, Facebook AI Research in Menlo Park, CA, published DeepFace: Closing the Gap to Human-Level Performance in Face Verification. DeepFace discloses the use of a four-stage pipeline, comprising: detect, align, represent, and classify. In its deep learning model, the representation stage uses a nine-layer deep neural network. The paper discloses an architecture comprising a front-end of a single convolution-pooling-convolution filtering on the rectified input, followed by three locally-connected layers and two fully-connected layers.

Images are aligned by detecting 6 initial fiducial points inside the detection crop (bounding rectangle) centered at the center of the eyes, tip of the nose and mouth locations. The detected face is scaled, rotated, and translated. Additional fiducial points are identified in the 2D-aligned crop. The image is 3D aligned by transforming Delaunay triangulation derived from the 67 fiducial points. The 3D-aligned image is given to the first layer of a large deep neural network.

As explained by Sefik Ilkin Serengil, the DeepFace deep learning model is a layered convolutional neural networks. Each layer is named with a letter and number. The number refers to the index from 1 to 8 and letter states the type of layer. C refers to convolutional layer, M refers to max pooling, L refers to locally connected layer and F refers to fully connected layer. https://sefiks.com/2020/02/17/face-recognition-with-facebook-deepface-in-keras

OpenFace is open source code. https://github.com/cmusatyalab/openface

OpenFace includes the FaceBook neural network source code. https://github.com/facebookarchive/fbnn

In December 2014, Baidu Research's Silicon Valley AI Lab, published Deep Speech: Scaling up end-to-end speech recognition. Deep Speech trained a large recurrent neural network (RNN) using multiple GPUs and thousands of hours of data. The structure of the RNN model is disclosed in the paper.

Cornell University's Cornell Lab of Ornithology, Merlin project was funded by the Natural Science Foundation. Photo ID, released Nov. 30, 2017, uses computer vision technology, developed as part of Dr. Grant Van Horn's doctoral work at Caltech, to identify birds in photos. Sound ID, released Jun. 23, 2021, learned to recognize the vocalizations of different bird species. Sound ID was trained on audio recordings that are first converted to visual representations (spectrograms), then analyzed using computer vision tools similar to those that power Photo ID. Both Photo ID and Sound ID run on smart phones, such as the Apple iPhone. https://merlin. allaboutbirds.org

Grant Van Horn's Phd thesis is entitled Towards a Visipedia: Combining Computer Vision and Communities of Experts, and details recent advances in the use of deep convolutional neural networks in image analysis.

U.S. Pat. No. 11,140,312, was filed by Swarovski-Optik Jul. 17, 2020 (Swarovski '312) U.S. Patent Application 2023/0283882 published Sep. 7, 2023 (Swarovski '882). Both disclose a smart binocular.

FIG. 3 shows binocular 400 comprising a housing 20 supporting an eyepiece 22, a lens 24, an input, an operating button, 32. The components inside the housing 20 comprise: computing element 16, memory 18, wireless communications 19, image sensor (digital camera) 25, audio sensor 29. Swarovski claims require several other elements. Swarovski discloses using the wireless communications 19 to communicate with a smart phone, such as an iPhone 11 (not shown) having a high-resolution, touch screen display 31 (not shown). While Swarovski '312 suggests that the smart phone 11 separately execute a mobile app which can recognize an image of a bird, it does not disclose a deep learning model running on the computing element 16 of the binocular 400. The type of bird is recognized by means of a remote image database and an image recognition algorithm. Further, Swarovski '312 discloses using the operating button 32 to start the image capture for object recognition, object detection, and object classification to be executed on the smart phone 11.

In 2019, Stanford University researchers published a paper, DeepWind: Weakly Supervised Localization of Wind Turbines in Satellite Imagery (DeepWind Wind Turbines) uses image recognition to map global wind energy infrastructure using satellite images and discloses weakly supervised convolutional neural networks to detect the presence and locations of wind turbines.

Chinese government funded researchers at College of Computer Science and Technology, Ocean University of China and School of Computing and Artificial Intelligence, Southwest Jiaotong University, issued a paper, available online on Jan. 20, 2024, DeepWind: a heterogeneous spatio-temporal model for wind forecasting. DeepWind for Numerical Weather Prediction (NWP) Correction discloses a deep learning heterogeneous network, which learns spatio-temporal representations, and which can simultaneously correct the NWP of diverse wind variables across multiple weather stations. Source code is released at https://github.com/Rittersss/DeepWind.

In January 2024, Swarovski Optik announced smart binoculars, namely, AX Visio 10×32 binoculars, comprising a neural processing unit (NPU) for object recognition processing, which identifies over 9,000 species of birds and mammals using Merlin Photo ID and Sound ID image recognition technology. See FIG. 3, binocular 400.

In January 2024, Apple unveiled chips having capabilities to run generative AI, for example, supporting billions of data parameters. The S9 chip allows Siri to access and log data without connecting to the Internet. The A17 Pro chip in the iPhone 15 comprises a neural engine which is twice as fast as previous generations. These advances will allow AI models to run directly on iPhones.

Thus, the deep learning models for recognizing and characterizing audio and images, as well as source code for implementing them, GPU systems for learning, and handheld devices for operating those deep learning models are well known in the art.

### Windage and Elevation

For hundreds of years, hunters and soldier have learned the mantra “Windage and Elevation.”

Our patented Flight Path® technology (disclosed, for example, in U.S. Pat. No. 9,057,587 referenced above) currently available in Leupold RX-FullDraw 5 and RX-1400i True Ballistic Range/Wind (TBR/W) Gen 2, does an excellent job of handling elevation by providing an aiming point corrected for shoot angle, distance, and ballistics along a vertical plane including the line of sight to a desired target.

However, there has been a long felt need to be able to accurately recognize the winds impact on a projectile and to quickly and dynamically make adjustments despite constant changing, difficult to interpret changes in the wind. Wind adjustment has been largely guesswork.

Until now accurate wind recognition has been the “Holy Grail” sought after by the industry.

What is needed is a device and methods for recognizing wind along a projectile trajectory path so that a user can accurately aim and hit a desired target regardless of the wind speed and direction at different points along the path. Further, what is needed is an indication that wind currently is in a likely sustained favorable state for a brief period of time, such that a user has time to aim and fire.

### SUMMARY OF THE INVENTION

The present invention solves the above-described problems and provides a distinct advance in the art of AI devices recognizing wind along a projectile trajectory path to a target. The present invention provides devices and methods for recognizing wind along a projectile trajectory path so that a user can accurately aim and hit a desired target regardless of the wind speed and direction at different points along the path. Further, an indication that wind currently is in a likely sustained favorable state for a brief period of time, such that a user has time to aim and fire. More particularly, the invention provides an AI device with an image sensor and/or audio sensor and a deep learning model wherein the sensor(s) and deep learning model are configured to recognize the reaction of an object, such as a string, to wind along the projectile trajectory path, and wherein the AI device outputs wind information regarding the projectile trajectory. The string is the teacher. Such information facilitates accurate, effective, and safe firing device use by providing an aiming point.

The AI device further comprises a computing element, a memory, and a display. The deep learning model operates on the computing element and memory and provides output to the display.

In one embodiment, the AI device further comprises wireless communication to communicate wirelessly with remote sensors, such as wind meters (also known as anemometers) or with a handheld rangefinder, smart scope, smart binocular, or other device.

The deep learning model comprises a deep neural network.

In some embodiments, the deep neural network is a convolutional neural network.

During training, inputs to the deep learning model comprise: a) wind speed and direction at a predetermined number of points along the projectile trajectory path, and data regarding the string, such as a still or video image and/or an audio recording.

In one embodiment, the sensor is an audio sensor.

In one embodiment, the sensor is an image sensor.

In one embodiment, both an image sensor and an audio sensor provide data regarding the current state effect of wind on the string.

In one embodiment, the AI device outputs wind speed and direction.

In one embodiment, the AI device outputs crosswind effect.

In one embodiment, the AI device outputs headwind or tailwind effect.

In one method embodiment to recognize wind along the projectile trajectory path to the target, steps comprise:
a. training the deep learning model,
b. placing the string on a plurality of support rods positioned along a segment of the projectile trajectory path,
c. placing AI device at the start of the projectile trajectory path where it can sense the string,
d. enabling sensing,
e. receiving outputs regarding the recognized wind speed and direction along the projectile trajectory path.

In one method embodiment to recognize wind along the projectile trajectory path to the target, steps further comprise displaying the crosswind speed on the display.

In one method embodiment to recognize wind along the projectile trajectory path to the target, steps further comprise displaying headwind or tailwind speed on the display.

In one embodiment, the AI device further comprises a rangefinder comprising:
i) crosshairs for positioning the rangefinder to range the target,
ii) an inclinometer for sensing the angle to the target, and
iii) an range sensor for determining the line of sight range to the target.

In one embodiment, the AI device display comprises a shoot-for range indicator,

In one embodiment, the AI device display comprises a shoot-for range indicator,

In one embodiment, the AI device display indicates a shoot-for range adjusted for shooting angle and headwind or tailwind.

In one embodiment, the AI device is embedded in a handheld rangefinder

In one embodiment, the AI device is embedded in a rifle scope.

In one embodiment, the AI device is embedded in a binocular.

In one embodiment, the AI device is embedded in a smart phone.

In one embodiment, the AI device is embedded in an iPhone.

In one embodiment, the AI device is embedded in a smart tablet.

In one embodiment, the AI device illuminates an aiming point adjusted for crosswind.

In one embodiment, the AI device determines an optimum wind speed which is sustained for a repeatable period of time and illuminates a green light when that optimum wind speed is present.

In another embodiment, the AI device determines an optimum wind speed which is sustained for a repeatable period of time and illuminates a yellow light when that optimum wind speed is approaching.

In yet another embodiment, the AI device determines that the wind is unstable or extreme and illuminates a red light.

In a system embodiment, the AI device, a plurality of flexible rods, and a string on a reel are provided as package.

In one system embodiment, the string is attached to the top of each of a plurality of rods and the flex of the rods are additional input to the deep learning model.

Further, in one system embodiment, the deep learning model detects the location of the rod in the image and recognizes the flex of the rod.

In some system embodiments, multiple strings are placed along different segments of the projectile trajectory path.

In other embodiments, the AI device detects a plurality of objects along the projectile trajectory path, such as grass, trees, or dust and recognizes wind information based on those objects in nature.

In other embodiments, the AI device observes a projectile's flight along the projectile trajectory path and determines the wind impact on the projectile.

In other embodiments, the AI device detects a plurality of strings, wind socks, weather vanes, or other objects along an airport runway recognizes wind information based on those objects at an airport.

In other embodiments, the AI device observes a projectile's impact relative to the target and determines an adjusted aiming point.

In other embodiments, the string is a tale tell connected to the sail of a sailboat or a wing of a glider or other aircraft and provides information about consistent flow or changes of the air across the sail or wing. In one of these embodiments the AI device provides a warning regarding a change in the air flow, or an imminent stall condition.

Other aspects and advantages of the present invention will be apparent from the following detailed description of the preferred embodiments and the accompanying drawing figures.

### OBJECTS AND ADVANTAGES

Accordingly, the present invention provides the following objects and advantages:
a) To provide a display that provides dynamic information regarding a projectile trajectory.
b) To provide a lightweight rangefinder comprising a high-resolution display and a digital camera, wherein the display provides an aiming point adjusted for wind effect.
c) To provide lightweight, handheld AI device for recognizing current wind along a projectile trajectory path to a desired target.
d) To provide an AI device, having a deep learning model, which is trained to recognize the wind effect along a projectile trajectory path.

### DRAWING FIGURES

A preferred embodiment of the present invention is described in detail below with reference to the attached drawing figures, wherein:

FIG. 1A illustrates an archer with a bow with a bow sight;

FIG. 1B illustrates a rifle with a scope;

FIG. 2 illustrates a smart binocular with a digital camera image sensor;

FIG. 3 is a block diagram of an AI device;

FIG. 4 illustrates the AI device in a housing and an operating button input;

FIG. 5 illustrates the training of the AI device with a string and wind sensors, positioned along a projectile trajectory path to a target;

FIG. 6A illustrates an archer with a bow and the projectile trajectory path of an arrow to a target;

FIG. 6B illustrates a user with a rifle and the projectile trajectory path of a bullet to a target;

FIGS. 7A through 7C illustrate a plurality of strings, each positioned at different segments and heights along a projectile trajectory path to a target;

FIGS. 8A through 8D illustrate a flexible rod and extensions, preferable marked with dark and light bands;

FIGS. 9A and 9B illustrate lockable inserting ends and receiving ends for embodiments of the flexible rod and extensions, and FIG. 9B further illustrates a ground stake for supporting the rod assembly;

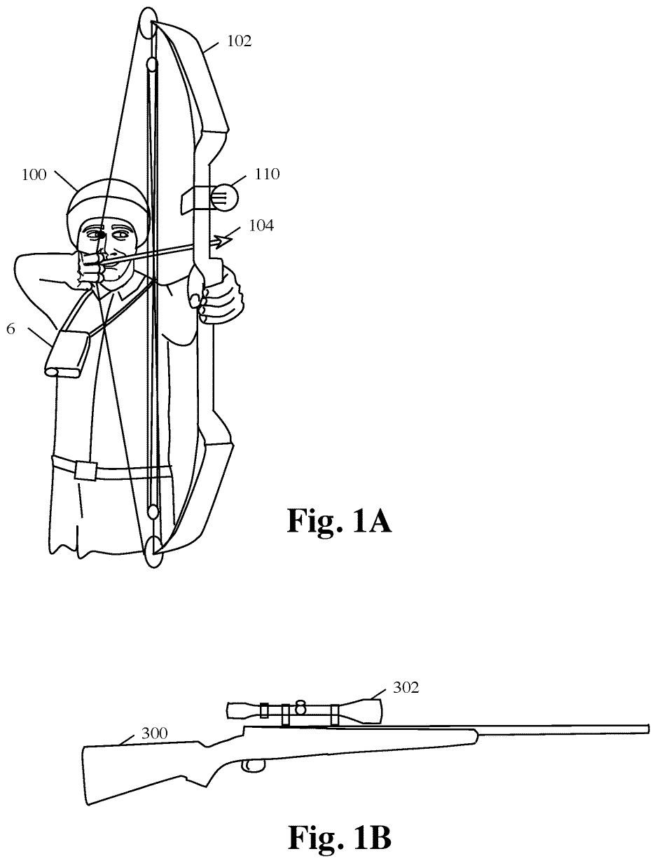

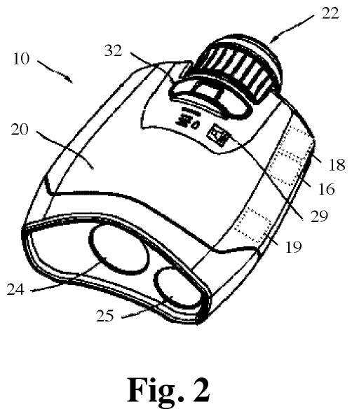

FIGS. 10A through 10F illustrate the use and operation of the AI device:
FIG. 10A illustrates the AI device with a string, positioned along a projectile trajectory path to a target,
FIG. 10B illustrates an image captured by the AI device showing string shape and position and the flex of the flexible rods supporting the string,
FIG. 10C illustrates a detection crop of the image with four bounding points forming a bounding rectangle containing the cropped image of the string and rods,
FIG. 10D illustrates fiducial points found on the string and rods,
FIG. 10E illustrates fiducial points defining the shape and position of the string,
FIG. 10F illustrates fiducial points defining the flex of the flexible rod;

FIGS. 11A and 11B illustrates a plurality of strings, each positioned at different angles relative to the projectile trajectory path to the target;

FIG. 12 illustrates a display with indication of the crosswind speed relative to the path to the desired target, and indicators of a predicted steady state of optimum wind;

FIG. 13 illustrates crosswind and tailwind vector elements of wind;

FIGS. 14A through 14B illustrate embodiments of display elements with crosswind speed and direction indicators and with headwind/tailwind speed indicator. FIG. 14B includes indicators of a steady state of optimum wind.

FIGS. 15A through 15C illustrate a display with indication of the crosswind speed and direction and headwind/tailwind speed, each relative to the path to the desired target, indicators of a steady state of optimum wind, and an adjusted aiming point, the aiming point adjusted for crosswind and range adjusted for tailwind/headwind.

FIG. 16 shows a high-resolution digital display, such as on an iPhone, providing indication of the crosswind speed and direction and headwind/tailwind speed, indicators of a steady state of optimum wind, and an adjusted aiming point, the aiming point adjusted for crosswind and range adjusted for tailwind/headwind.

FIG. 17 is a rear perspective view of a digital rangefinder device;

FIG. 18 is a front perspective view of the rangefinder device of FIG. 17;

FIG. 19 illustrates a string and flexible rods placed in a harsh, rough environment with hills and valleys and strong winds at different speeds and directions along the projectile trajectory path.

The drawing figures do not limit the present invention to the specific embodiments disclosed and described herein. The drawings are not necessarily to scale, emphasis instead being placed upon clearly illustrating the principles of the invention.

### REFERENCE NUMERALS IN DRAWINGS

1 line of departure
2 projectile trajectory
3 line of sight
6 rangefinder
10 AI device
11 iPhone
12 range sensor
14 tilt sensor
16 computing element
18 memory
19 wireless communications
20 housing
22 eyepiece
24 lens
25 image sensor (digital camera)
26 distal end
28 proximate end
29 audio sensor
30 display
31 high-resolution display
32 inputs
36 image
37 a-d bounding point
38 fiducial point
40 a-c string
42 crosswind
44 headwind
46 tailwind
48 wind
52 crosswind vector
56 tailwind vector
100 archer or user
102 bow
104 arrow
106 flexible rod
110 bow sight
300 rifle
320 twenty-yard line
340 forty-yard line
400 binocular
680 a-c wind sensor
800 marking pattern
802 dark band
804 light band
900 cross hairs
914 horizontal distance indicator
918 left/right indicator
922 crosswind indicator
924 green indicator
926 yellow indicator
928 red indicator
930 (selectable) path indicators
944 tailwind indicator
982 aiming point
1070 inserting end (male)
1072 receiving end (female)
1097 protrusion indicator
2235 horizontal leg
3094 locking channel
3104 sleeve
3196 outward protrusion
3450 stake
3454 stake member
P a-c, 0, 20, 40 point
θ angle (theta)
T target
V vertex

### DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### The String

Over a decade ago we performed an experiment with a 270-yard string 40 supported by two flexible rods 106 in a harsh, rough environment with hills and valleys and strong winds at different speeds and directions along the projectile trajectory path to a target T (see FIG. 19). We discovered that the “string is the teacher.” By observing the effects of the combined winds on the string, including both the sounds and the visual image of the string and the flexible rods, a human users could determine a period of consistent wind, adjust their aim for that wind, and repeatedly hit the target using that aim each time the users sensed the presence of the optimum steady wind conditions. The sound of the wind was easier to distinguish at higher wind speeds. In our experiment, the string taught us how to adjust our aim and when we could repeat a shot under the same and highly similar instantaneous wind conditions. The bullets consistently hit a desired target at 270 yards in strong dynamic wind conditions.

In our experiment, we used a 600-yard spool of 80 pound test Izorline braided low stretch Dacron fishing line, UPC 8783700307. The string was white with “greenspot” spiral markings.

We discovered that the string is the teacher. What was needed were low cost, light weight, portable platforms with high quality optics, digital camera, and computing capabilities so that we could implement a machine learning solution which could also be taught by the string, and could instantaneously observe current wind effects and provide crosswind, headwind/tailwind, information; could determine a the presence of a stable optimum wind, and an adjusted aiming. With advances in AI technology and platforms that can be made available to general users, we can now implement our invention as devices and methods for recognizing wind along a projectile trajectory path so that a user can accurately aim and hit a desired target regardless of the wind speed and direction at different points along the path, and provide an indication that wind currently is in a likely sustained favorable state for a brief period of time, such that a user has time to aim and fire.

Accordingly we disclose the following AI devices and methods.

### AI Device

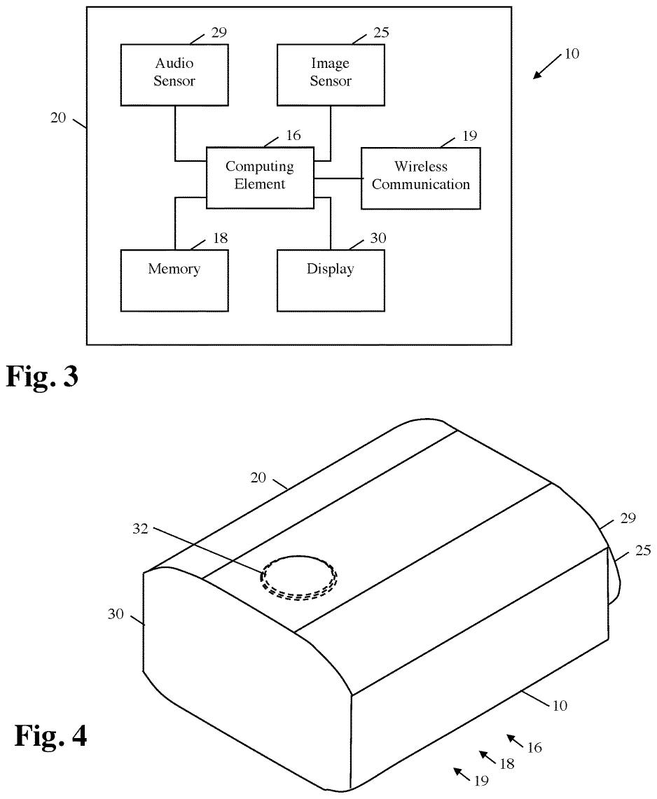

FIG. 3 illustrates our novel AI device 10 comprises a computing element 16, coupled with an audio sensor 12 or an image sensor 14, a display 30. A housing 20 contains the elements of the device 10.

FIG. 4 shows our novel AI device 10 comprising a housing 20 supporting a display 30, an operating button input 32. The components inside the housing 20 comprise: computing element 16, memory 18, wireless communications 19, image sensor (digital camera) 25, audio sensor 29. One or both of the image sensor 25 and the audio sensor 29 is configured in different embodiments.

The display 30 could be a high-resolution, touch screen display 31 (see FIGS. 10B, 15A through 15C, 16, 17, and 18).

Comparing FIG. 4 to FIG. 2 results in understanding that while Swarovski AX Visio is an enabling platform for our present invention, it contains elements which are not required by our present invention. In other words, the reader should understand that the present invention could be implemented entirely on a Swarovski AX Visio binocular or similar device, but could also be implemented as disclosed herein without requiring the invention claimed by Swarovski. Further, Swarovski only clearly discloses identification of birds and mountain peaks. It is silent on recognizing wind or on projectile trajectory paths.

The handheld housing 20 enables AI device 10 to be easily and safely transported and maneuvered for convenient use in a variety of locations.

For example, the portable handheld housing 20 may be easily transported in a backpack for use in the field. Additionally, the location of the components on or within the housing 20 and the location of the button 32, enables AI device 10 to be easily and quickly operated by the user with one hand without a great expenditure of time or effort.

A computer program preferably controls input and operation of the AI device 10. The computer program includes at least one code segment stored in or on a computer-readable medium residing on or accessible by AI device 10 for instructing computing element 16, image sensor 25, audio sensor 29, and any other related components to operate in the manner described herein. The computer program is preferably stored within the memory 18 and comprises an ordered listing of executable instructions for implementing logical functions in AI device 10. However, the computer program may comprise programs and methods for implementing functions in the device 10 which are not an ordered listing, such as hard-wired electronic components, programmable logic such as field-programmable gate arrays (FPGAs), application specific integrated circuits, conventional methods for controlling the operation of electrical or other computing devices, etc.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

AI device 10 and computer programs described herein are merely examples of a device and programs that may be used to implement the present invention and may be replaced with other devices and programs without departing from the scope of the present invention.

The computing element 16 is coupled with image sensor 25, audio sensor 29 to determine ballistic information relating to the target T, including wind effect information, as is discussed herein. The computing element 16 may be a microprocessor, microcontroller, or other electrical element or combination of elements, such as a single integrated circuit housed in a single package, multiple integrated circuits housed in single or multiple packages, or any other combination. Similarly, the computing element 16 may be any element that is operable to determine clear shot information from the range and angle information as well as other information as described herein. Thus, the computing element 16 is not limited to conventional microprocessor or microcontroller elements and may include any element that is operable to perform the functions described.

The memory 18 is coupled with the computing element 16 and is operable to store the computer program and a database including trained representation and classification for comparison, and configuration information. The memory 18 may be, for example, an electronic, magnetic, optical, electromagnetic, infrared, or semi-conductor system, apparatus, device, or propagation medium.

The device 10 also preferably includes a display 30 to indicate relevant information such as the cross hairs 900, distance indicator 910, and other indicators disclosed herein. The display 30 may be a conventional electronic display, such as a low resolution pixel matrix, OLED, TLED LED, TFT, or LCD display.

The inputs 32 are coupled with the computing element 16 to enable users or other devices to share information with AI device 10. The inputs 32 are preferably positioned on the housing 20 to enable the user to simultaneously view the display 30 and function the inputs 32.

The inputs 32 preferably comprise one or more functionable inputs such as buttons, switches, scroll wheels, etc., a touch screen associated with the display 30, voice recognition elements, pointing devices such as mice, touchpads, trackballs, styluses, combinations thereof, etc. Further, the inputs 32 may comprise wired or wireless data transfer elements.

### Training

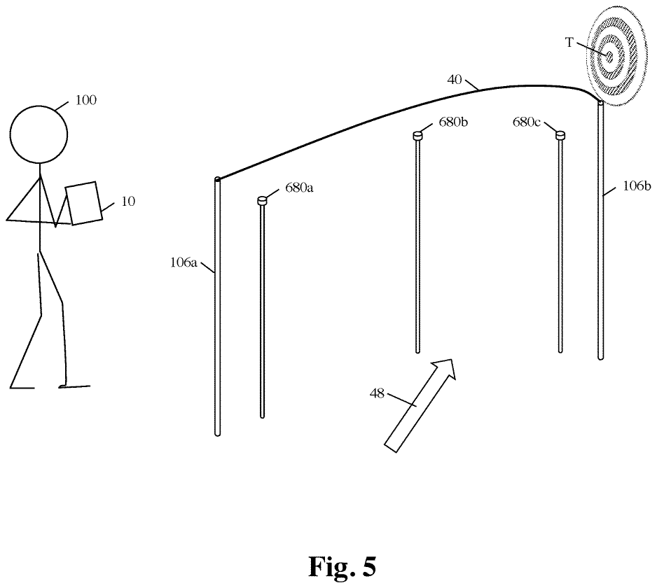

FIG. 5 illustrates the training of the AI device 10 with a string 40 and wind sensors 680a through 680c, positioned along a projectile trajectory path to a target T.

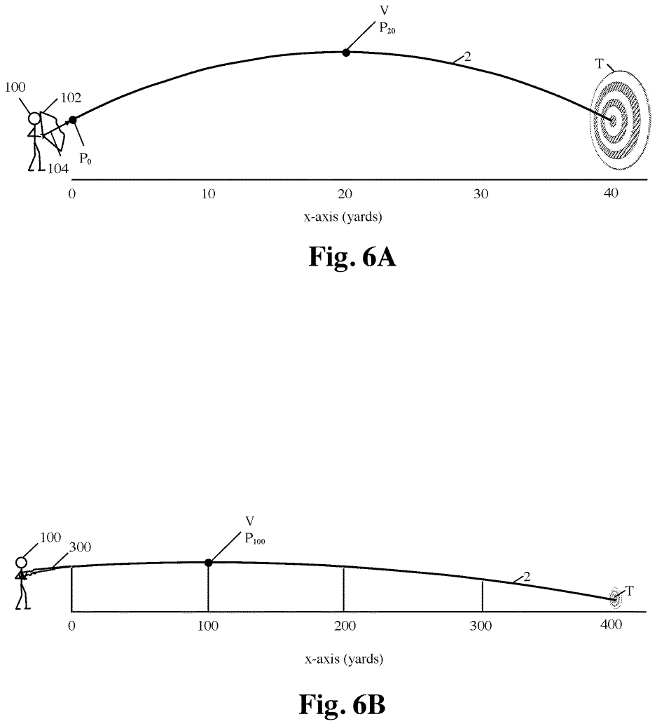

The user 100 is shown with the AI device 10. The string 40 is supported two flexible rods 106, namely near rod 106a and a far rod 106b. The rods 106 hold the string 40 off the ground in the wind 48 along at least a segment of the projectile trajectory path 2 (shown, for example, in FIG. 6A and FIG. 6B).

The string 40 shows that the wind 48 has both a tailwind and left moving cross wind (see FIG. 13). The tailwind is evidenced by the curve of the string 40 toward the target T, at the far rod 106b. The left moving crosswind is evidenced by the curve of the string 40 toward the left of the line of sight to the target, and to the left of the two rods 106.

The AI device 10 is positioned where it can sense the string 40 and the rods 106. In some embodiments, the AI device 10 senses the sound made by the wind 48 as it moves and passes over the string 40. In some embodiments, the AI device 10 senses the image made by the wind 48 as it dynamically moves the string 40 and flexes the rods 106. In other embodiments it senses both sound, with the audio sensor 29 (FIG. 3 and FIG. 4), and photos or videos, with the image sensor 25 (FIG. 3 and FIG. 4).

A plurality of wind meters 680 (also known as anemometers) are shown positioned along path of the string 40.

Wind meters are well known in the art, such as Kestrel 1000 wind meter or the Kestrel 3550FW fire weather meter. Wind meters are known to provide wind direction and speed via wireless communications.

Our U.S. Pat. No. 8,795,109, issued Aug. 5, 2014, and U.S. Pat. No. 9,482.505, issued Nov. 1, 2016, both included by reference, disclose and claim a wind tracking apparatus which can be deployed by shooting an arrow comprising an wind meter or wind sensor 680 on nock end of the arrow, which then wireless transmits wind speed and direction. One wind meter or sensor was disclosed as an ultrasonic anemometer.

A large multiplicity of images 36 (FIG. 10B) and/or audio are captured by an embodiment of the AI device 10, such binocular AI device 10 of FIG. 2, or other conventional recording means such as cameras, audio records, or smart phones 11, such as iPhones. The multiplicity of images 36 (FIG. 10B) and/or audio are capture while observing the string 40 during thousands of different wind conditions. With each image or audio capture, the wind information from the plurality of wind meters 680 are received wirelessly and stored in a dataset along with each image or audio recording. The dataset is used as input to train the deep learning model of the AI device 10.

### Projectile Trajectory Paths

FIG. 6A illustrates an archer 10 with a bow 102 and the projectile trajectory path 2 of an arrow 104 to a target T. As discussed above the path is generally parabolic but is affected by many factors for the true ballistic path.

As shown in FIG. 6A the arrow starts at point P₀ and at 20 yards pass through point P₂₀, which is the vertex V of the projectile trajectory path 2, when aimed at a 40-yard target T.

FIG. 6B illustrates a user with a rifle 300 and the projectile trajectory path 2 of a bullet to a target T.

As shown in FIG. 6B the bullet starts at point about 5 feet above the ground and then climbs to a vertex V at 100 yards, passing through point P₁₀₀, when the rifle is aimed at a 400-yard target T. The vertex V about 5 ½ feet above the ground (e.g., 6 inch rise). The path is about 5 feet at 200 yards and 3 ½ feet at 300 yards. The path drops off quickly to the target during the last 100 yards as the bullet velocity drops due to wind drag.

As seen in both FIG. 6A and FIG. 6B, the projectile trajectory path 2 is higher than the height at P0. Accordingly, the wind may be different at different height, and it would be preferred to recognize the wind 48 at different heights.

### Multiple String Segments at Different Heights

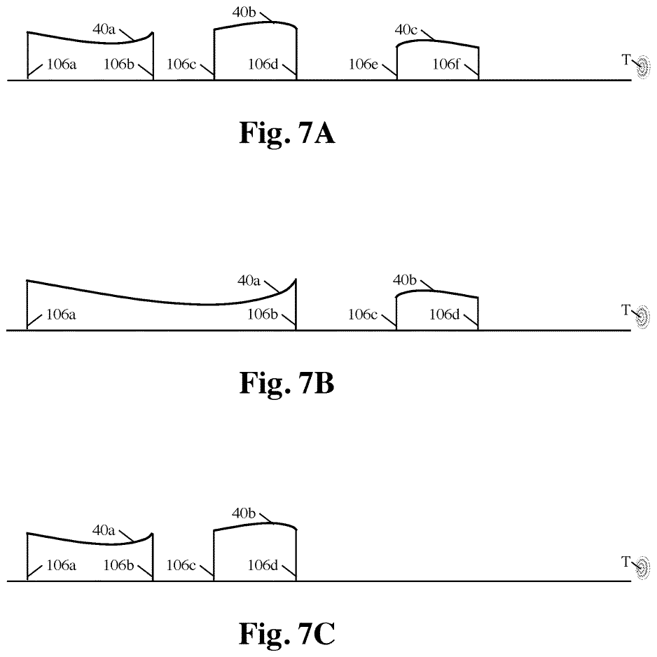

FIGS. 7A through 7C illustrates a plurality of strings 40, each positioned at different segments and heights along a projectile trajectory path 2 (shown in FIG. 6A and FIG. 6B) to a target T. As shown in each figure, the wind's effect on the string 40 may be different in each segment.

FIG. 7A shows three strings 40a through 40c, respectively, support by pairs of rods 106, 106a-b, 106c-d, and 106e-f, respectively. String 40b is supported at a higher position than 40a. String 40c is supported at a lower position than string 40a. These heights correspond to the projectile trajectory path 2 for a rifle (shown in FIG. 6B). For example, string 40a is supported at 5 feet, string 40b is supported at 5 ½ feet, and string 40c is supported at 3 ½ feet. At these different heights the AI device 10 can better recognize the wind effect on the bullet, e.g., along projectile trajectory path 2 for a rifle (shown in FIG. 6B).

FIG. 7B shows two strings 40a and 40b, respectively, support by pairs of rods 106, 106a-b and 106c-d, respectively. String 40a is supported at a higher position along a relative longer segment.

FIG. 7C shows two strings 40a and 40b, respectively, support by pairs of rods 106, 106a-b and 106c-d, respectively. String 40b is supported at a higher position near the vortex. String 40a would help detect the initial wind impact on the path. String 40b would detect the wind impact at the higher part of the path.

### Flexible Rods and Extensions

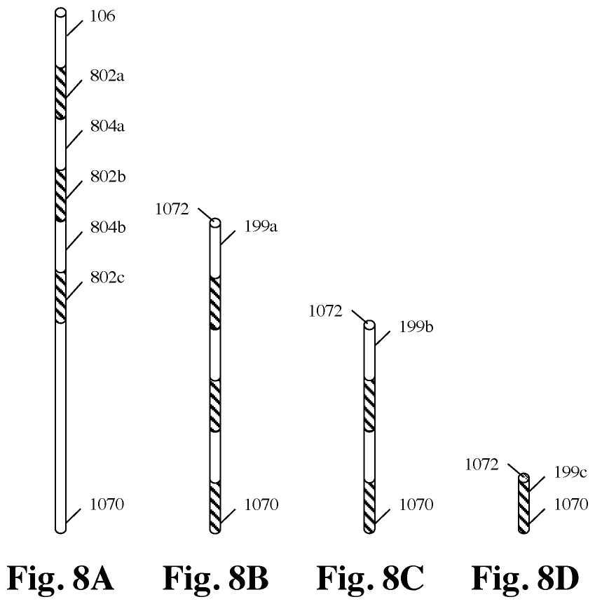

As shown in the previous figures, it is advantageous to have rods 106 of different lengths. FIGS. 8A through 8D illustrates a flexible rod 106 and extensions 199b, preferable marked with dark bands 802 and light bands 804.

FIG. 8A illustrates a flexible rod 106, preferable marked with dark bands 802 and light bands 804. Dark bands 802a, 802b, and 802c are preferably 6-inches long and are separated by 6-inch long light bands 804a and 804b. In this preferred embodiment the rod is 5 feet long, and the 3 feet are easily identified at the bottom of each dark band 802, namely, 1 foot at the bottom of 802a, 2 feet at the bottom of 802b, and 3 feet at the bottom of 802c. The bottom of the rod 106 is an inserting end 1070.

The dark bands 802 and light bands 804 of a predetermined length aid the AI device is detecting the location and flex of the rod 106. Further, the AI device determines the distance from the AI device to each rod 106 and determines length of the string based on the distance between the near rod 106a and the far rod 106b. While not required, the dark bands 802 and light bands 804 enhance the captured images 36 and improve the rod 106 and string 40 recognition, detection, and alignment.

FIG. 8B illustrates a 3-foot rod extension 199a, preferable marked with dark bands 802 and light bands 804.

FIG. 8C illustrates a 2-foot rod extension 199b, preferable marked with dark bands 802 and light bands 804.

FIG. 8D illustrates a 6-inch rod extension 199b, preferable marked with a dark band 802.

The bottom of each rod extension 199 is an inserting end 1070.

The different rod 106 and rod extension 199a through 199c sizes provide for configuration of support rods 106 of different lengths. However, the rod can be broken down and carried in a smaller bag. A 5-foot rod 106 is configured from a 3-foot extension 199a and 2-foot extension 199b. All three extensions 199a-c could be configured for the 5 ½ foot support needed to place a wind sensor 680 at P₁₀₀ in FIG. 6B.

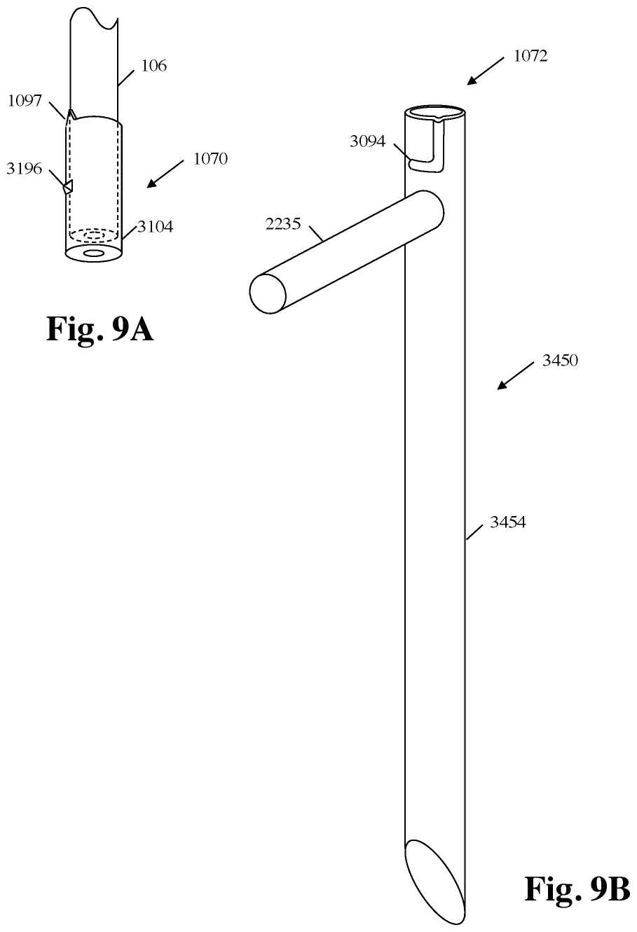

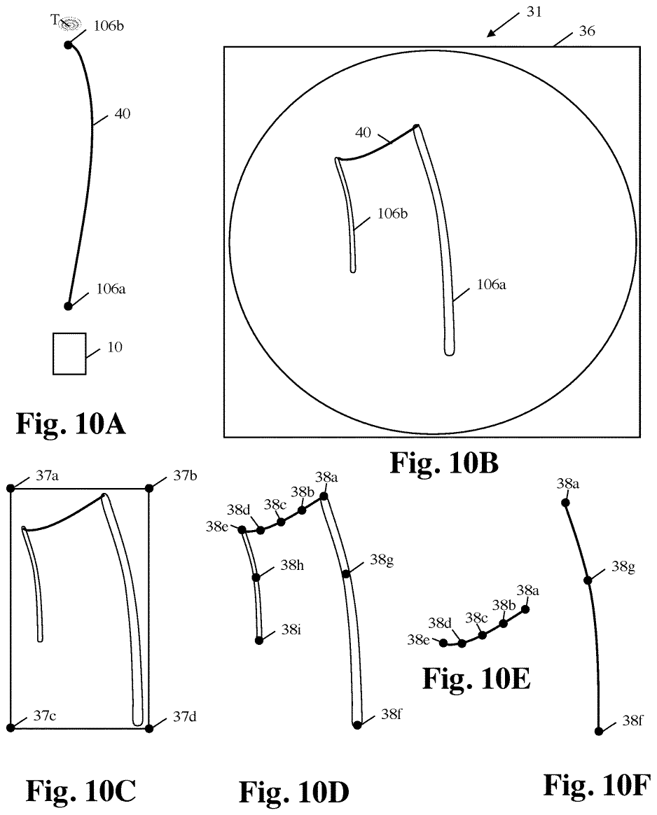

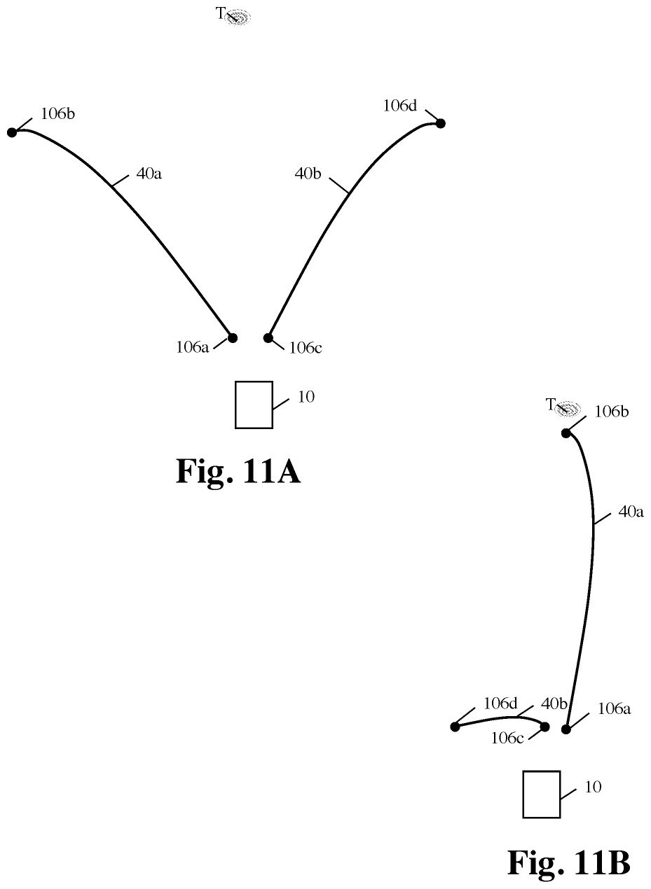

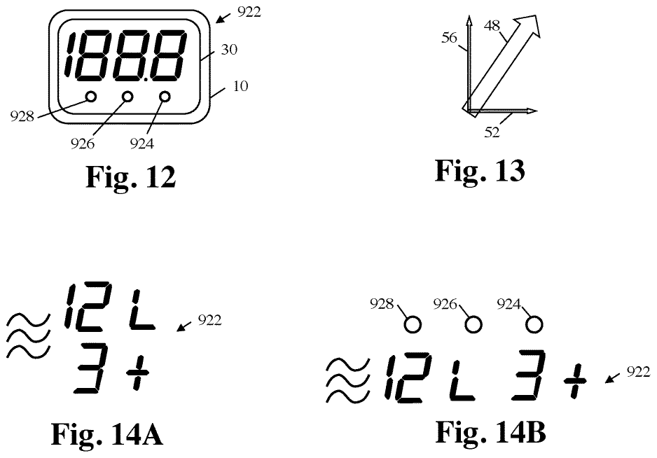

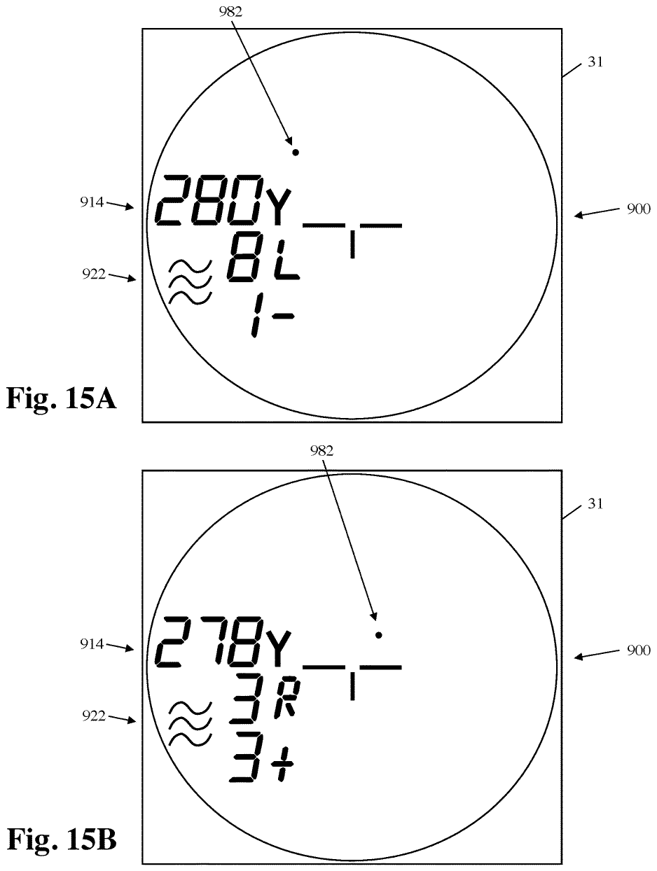

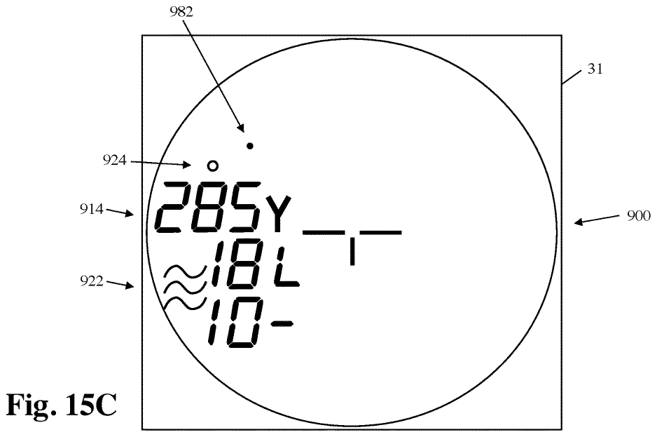

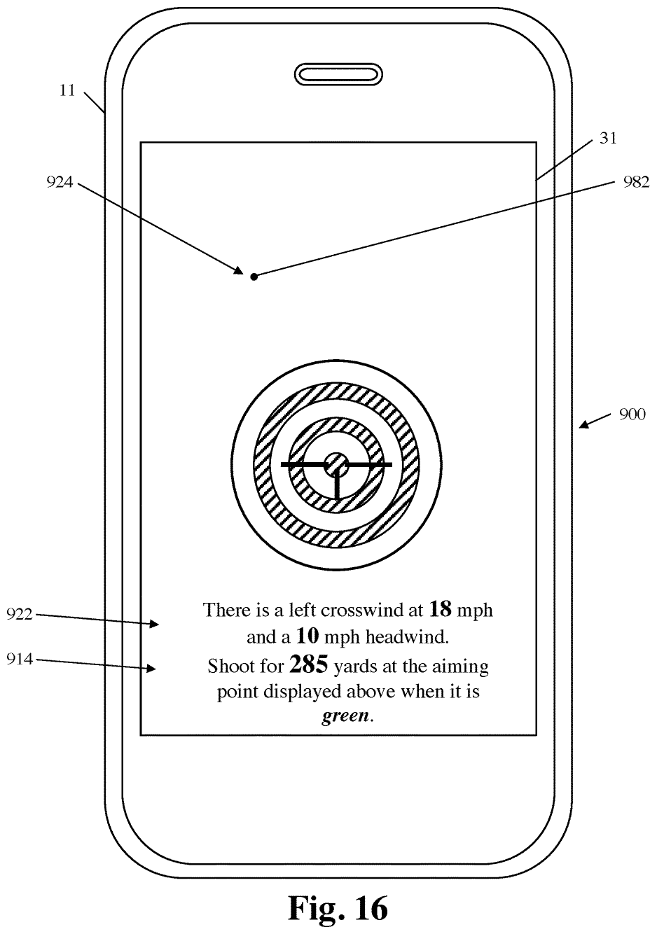

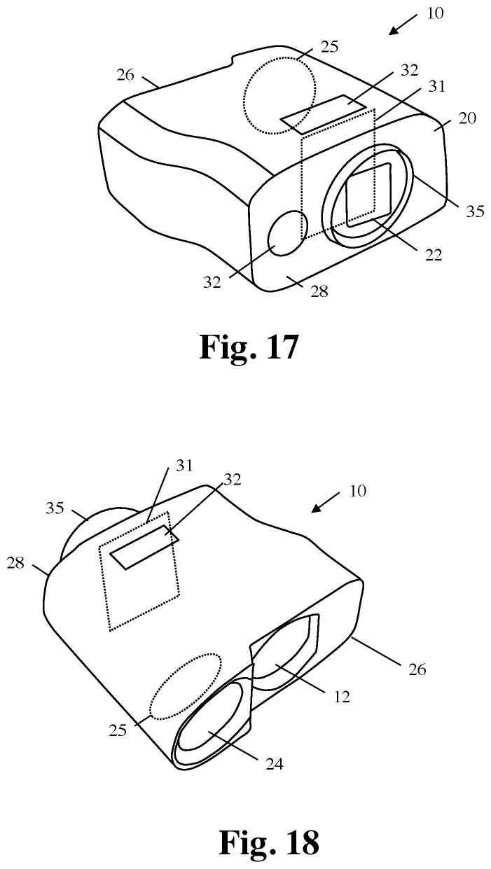

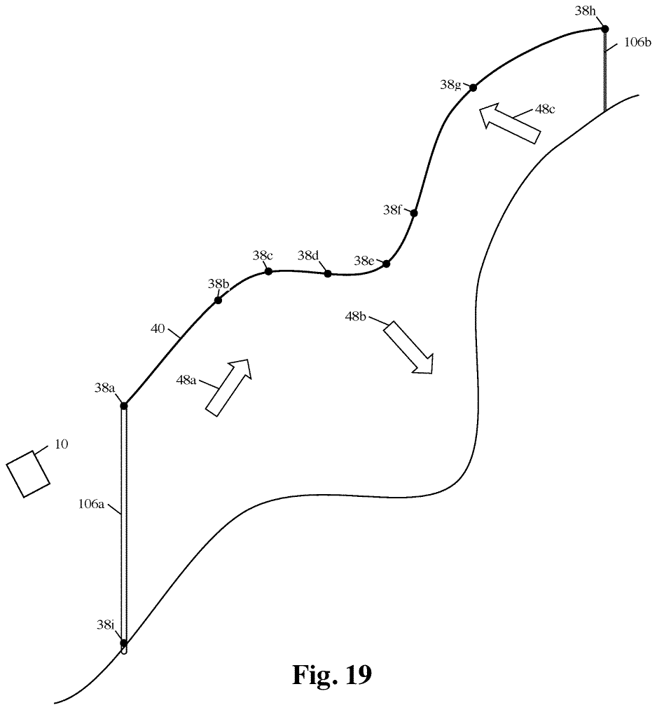

FIGS. 9A and 9B illustrates lockable inserting ends 1070 and receiving ends 1072 for embodiments of the flexible rod and extensions. FIG. 9B further illustrates a ground stake 3450 for supporting any rod assembly (comprising rod 106 and extensions 199).

Our U.S. Pat. Nos. 7,841,355 and 8,789,550 disclose sleeve 3104 having an outward protrusion 3195 and protrusion indicator 1097, shown on the inserting end 1070 in FIG. 9A, and a locking channel 3094 on the receiving end 1072 and a ground stake 3450 as shown in FIG. 9B.

The ground stake 3450, in addition to the locking receiving end 1072, comprises a pointed stake member 3454 for insertion into the ground, and a horizonal leg 2235 which aids ground insertion and removal. For example, a user steps on the horizontal leg when placing the rod 106 in the ground.

Each of the inserting ends 1070 rod 106 and rod extension 199a through 199c can be inserted and locked into any of the receiving ends 1072 of rod extensions 199 and the ground stake 3450, to configure a flexible rod 106 which can be removably placed in the ground.

### Deep Learning Model Use and Operation

FIGS. 10A through 10F illustrates the use and operation of the AI device 10.

FIG. 10A illustrates positioning the AI device 10, flexible rods 106a and 106b, and the string 40 along a projectile trajectory path to a target. The AI device should be positioned about six feet from the near rod 106a with a full view of the string 400 and both rods 106a and 106b. This is the positioning step.

FIG. 10B illustrates an image 36 captured by the AI device 10. The image is displayed on a high-resolution display 31, showing the shape and position of the string 40. The image 36 also shows the flex and relative positions of the flexible rods 106a and 106b, which also mark the ends of the string 40. This is the capture step.

FIG. 10C illustrates a detection crop from the image 36 with four bounding points 37 forming a bounding rectangle containing the cropped image of the string 40 and rods 106, which is cropped from the image 36 of FIG. 10B. This is the first part of the detection step.

FIG. 10D illustrates fiducial points 38 found on the string and rods of the cropped image of FIG. 10C. Fiducial points 38a through 38e mark the curve of the string in the cropped image. Fiducial points 38a and 38f mark the ends of the near rod in the cropped image. Fiducial points 38e and 38i mark the ends of the far rod in the cropped image. Fiducial points 38a, 38g, and 38f mark the curve of the near rod. Fiducial points 38e, 38h, and 38i mark the curve of the far rod. Determining the fiducial points 38 is the second part of the detection step.

Knowing the focal magnification of the image, and preferably using the dark band 802 and light bands 804 visualized in the captured image, the computing element 16 (FIG. 3 and FIG. 4) can determine the distance of the near rod 106a from the image sensor 25, the distance from the near rod 106a to the far rod 106b which is the same as the length of the string 40, and the length of the rods 106. Later, the alignment step uses these length and distances to scale the cropped image.

The distance of the near rod 106a from the image sensor 25 optionally is an input to the deep learning model.

FIG. 10E illustrates fiducial points 38 defining the shape and position of the string (in this case 38a through 38e).

FIG. 10F illustrates fiducial points 38 defining the flex of a flexible rod (in this case 38a, 38g, and 38h showing the curve of the near rod 106a.

Next in the alignment step, the cropped image scaled to a standard size. The length of the near rod is used as the standard for scaling. Thus the user can place the AI device 10 at any reasonable distance from the near rod 106a. This removes the need for the user to measure the placement for accuracy of the deep learning model.

DeepFace teaches that near 100% face recognition can be achieved with both 2D rotation and 3D alignment. Alignment is optional. In our preferred embodiment 3D alignment using the fiducial points 38, as well as determined lengths and distances, is used to align the top of both rods in the center of the aligned image such that the flex of both rods and the entire string curve(s) are visualized in the aligned image. This removes the need for the user to worry about the height or exact placement of the AI device when capturing images.

These comprise the alignment step. The alignment is applied by transforming the fiducial points. After the fiducial points have been aligned, the image pixels are no longer needed,

The cropped, scaled, 2D aligned, and optionally 3D aligned fiducial points for each of a multiplicity of images 36, as well as the wind sensor information captured at the same time as the image, are given as inputs to the deep neural networks (DNN). Optionally a concurrent sound recording is converted to a spectrogram and the spectrogram fiducial contours are given as an input to the DNN.

The DNN is trained on the wind recognition task with a goal of output a wind direction and speed in relation to the directional alignment of the bottom of each rod 106 (which represents the direction of the target T. In a currently preferred embodiment, there is no need to visualize or detect the target itself. This simplifies the parameters of the DNN.

In simple terms, the DNN is used to classify the multiplicity of images 36 to a particular crosswind class (and optionally headwind/tailwind class). Once trained the AI device 10 can classify a single new image and/or sound, and output a particular crosswind and tailwind based on a matching class. See operation below.

In practice a very small percentage of shots need to be taken in winds greater than 30 mph. Thus, the ability to identify 60 distinct classes for cross wind (e.g., 30 from left cross winds from 0 to 30 mph and 30 for right cross winds from 0 to 30 mph) should be sufficient for general hunting or target shooting applications. Our model thus is less complex, smaller, and faster than the DeepFace model.

DeepFace also teaches that the number of layers in the DNN can be varied to simplify or to enhance the error rates. Accordingly, one skilled in the arts of computer vision and machine learning, and in particular DNN-based image classification would be able to modify the DNN to meet their particular needs and parameters of their product (such as process speed, memory size, battery life, etc.).

In one embodiment of the DNN, only the string fiducial points 38 are used. In another embodiment of the DNN only the rod fiducial points 38 are used. In yet another embodiment only the near rod fiducial points and the sound fiducial contours are used. To be clear, each input is labeled with sensed wind values from one or more wind sensors 860.

In yet other embodiment, the strings 40 and rods 106 are positioned at an angle such as a 90 degree angle from each other.

FIGS. 11A and 11B illustrate a plurality of strings 40, each positioned at different angles relative to the projectile trajectory path to the target T;

FIG. 11A illustrates a left string 40a supported by rods 106a and 106b generally angled 45 degrees to the left of the target T, and a right string 40b supported by rods 106c and 106d generally angled 45 degrees to the right of the target T, such that the strings 40a and 40b generally form are 90 degree angle.

FIG. 11B illustrates a string 40a supported by rods 106a and 106b generally angled along the projectile trajectory path to the target T, and a tailwind string 40b supported by rods 106c and 106d generally angled 90 degrees generally on a line perpendicular to the target T, such that the strings 40a and 40b generally form are 90 degree angle. String 40b is much shorter than string 40a, as its role is to measure headwind and tailwind relative at the origin of the shot, and so it is more easily visualized in the field of view of the AI device 10. The embodiment shown in FIG. 11B is currently preferred over the model shown in FIG. 10A when headwind/tailwind output is desired from the DNN.

### Field Use and Operation and the Trained AI Device

FIG. 12 shows an embodiment of display 30 as shown for example on the form factor of the AI device 10 shown in FIG. 4. This embodiment does not require a high-resolution display 31 (for example, as shown in FIG. 10B, FIGS. 15A through 15C, or FIG. 16). This embodiment of AI device 10 may be carried by hand or mounted in a fixed position, such as on a tripod at a shooting range or on a tree stand or in a hunting blind. Under one setting it operates automatically to periodically display crosswind information, in a crosswind indicator 922, and, optionally, display the state of a steady optimum wind condition by illuminating at green indicator 924. A yellow indicator 926 indicates that the optimum wind condition is approaching. The red indicator 928 indicates that the wind is too strong or unpredictable at the moment.

FIG. 13 illustrates crosswind and tailwind vector elements of wind 48, namely crosswind vector 52 is the crosswind element and tailwind vector 56 is the tailwind vector which is in the negative director for headwind.

FIGS. 14A through 14B illustrate embodiments of display 30 or high-resolution display 31 elements with crosswind speed indicators and with headwind/tailwind speed indicators as part of crosswind indicator 922. A wind icon is shown as three waves as a visual clue to the viewer. As shown the current crosswind has been recognized as 12 mph moving to the left as indicated by “12 L” and there is a 3-mph tailwind as indicated by the plus sign in “3+”. FIG. 14B further includes indicators of a steady state of optimum wind, namely the green indicator 924, yellow indicator 926, and red indicator 928, as described above.

FIGS. 14A through 14B are based on the crosswind vector 52 and tailwind vector 56 in relation to the wind 48 relative to the path to the targets (see FIG. 13).

The handheld portable use and operation of trained AI device 10 is now discussed in more detail.

In operation, the user aligns AI device 10 with the target T and views the target T on the display 30. The AI device 10 may provide generally conventional optical functionality, such as magnification or other optical modification, by utilizing a lens 24 and/or the computing element 16. Preferably, the device 10 provides an increased field of vision as compared to conventional riflescopes to facilitate conventional view functionality. The focal magnification, typically is 4×, 5×, 7×, 12× and so forth. In some embodiments the magnification factor is variable, such as with a zoom feature. This magnification value is used by the computing element 16 in performing the mapping of the various indicators, and operating the deep learning model on the captured image is discussed in reference to FIGS. 10A through 10F above.

Further, the user may function the inputs 32 to control the operation of AI device 10. For example, the user may activate AI device 10, provide configuration information, and/or turn on or off automatic operation, or manually initiate a capture and recognition sequence by functioning one or more of the inputs 32.

### High-Resolution Display Use and Operation

FIGS. 15A through 15B illustrate a high-resolution display 31 showing an aiming point 982 based on a projectile trajectory path adjusted for wind using the deep learning model of the present invention. The crosshairs 900 are used to aim the AI device 10 towards the target, providing an input to the deep learning model the direction of the line of sight to the target. It also displays the captured image for recognizing current wind (as shown in FIG. 10B.

FIGS. 15A and 15B each shows a high-resolution display 31 providing digital video superimposed with horizontal distance indicator 914, crosswind indicator 922, and adjusted aiming point 982. The adjusted aiming point 982, in this embodiment, doubles as the green indicator 924.

FIG. 15A shows an output from the deep learning model. There is an 8-mph cross wind moving left and a 1-mph headwind. The user is guided to shoot for 280 yards at the dynamically moving adjusted aiming point 982 when it turns green.

FIG. 15B shows an output from the deep learning model after the wind has shifted. There is a 3-mph cross wind moving right and a 3-mph tailwind. Accordingly, the user is guided to shoot for a shorter distance of 278 yards at the dynamically moving adjusted aiming point 982 when it turns green.

FIG. 15C shows yet another embodiment where green indicator 924 is in a permanent position near the center of the user's field of vision. The wind is much stronger. There is an 18-mph cross wind moving left and a 10-mph headwind. Accordingly, the user is guided to shoot for a longer distance of 285 yards at the dynamically moving adjusted aiming point 982, when the separate green indicator 924 is illuminated.

### High-Resolution Digital Display

FIG. 16 shows a high-resolution display 31 providing digital video superimposed with horizontal distance indicator 914, crosswind indicator 922, and adjusted aiming point 982. The adjusted aiming point 982, in this embodiment, can double as the green indicator 924. This embodiment has very simple use for the operator, for example, the text on the screen simply states, “There is a left crosswind at 18 mph and a 10 mph headwind. Shoot for 285 yards at the aiming point displayed above when it is green,” or even simpler “Aim at the dot and shot when it turns green.”

This simple embodiment is an example of our best mode embodiment which we intend to market under the AimFinder™ trademark.

FIG. 16 shows a digital, high-resolution display 31, in this example, a touch screen display of an Apple iPhone 11.

One advantage of a digital, high-resolution display 31 is that it is not limited to the circular optical focus area. The additional area of the rectangular display can be used for various purposes. Information can be moved outside the circular focus area, for example, to the lower corners and bottom of the screen. This has the advantage of allowing the circular focus area to be less cluttered and to obscure less of the optical image information. Further, the rectangular high-resolution display 31 can provide more optical information.

Another advantage of a high-resolution display 31 is that the overlay information is produced by software rather than by a hardware chip. Custom hardware chips can be expensive to design and manufacture and are less flexible. The overlay information generated by software for display on the high-resolution display 31 is higher quality, such as easier to read fonts, and move flexible, such as being able to display in different colors or locations of the screen to avoid obscuring the optical information being overlaid. The display can have more options, such as natural languages, different number systems such as Chinese, different units of measure, and so forth. Further, the software can be easily updated to incorporate new features, to improve calculations, or to support addition projectile information. Updates can be made in the field as well as in new models at a lower cost. For example, in some embodiments, new software can be downloaded over the Internet.

### High-Resolution Touch Screen Display

FIG. 16 also shows an exemplary touch screen display as an embodiment of the high-resolution display 31. The high-resolution display 31 displays the video image as digitally captured by the digital camera 25 (see FIGS. 3 and 4).

The embodiment shown comprises a mobile smart phone, in particular an Apple iPhone 11. Correlating FIG. 3 with FIG. 16, the computing element 16 is the processor of the iPhone 11; the memory 18 is the memory of the iPhone 11; a tilt sensor 14 is the 9-axis magnetic compass, gyroscope, and accelerometer of the iPhone 11; and the display 30 is the touch screen display of the iPhone 11, an embodiment of the high-resolution display 31.

### Digital AI Devices

FIGS. 17 and 18 are rear and front perspective views, respectively, of a digital embodiment of AI device 10.

The digital AI device 10 comprise a housing 20, having an eyepiece 22 at the proximate end 28, a lens 24, an optional range sensor 12 at the distal end 26, and inputs 32 in various places on exterior. In contrast to the conventional rangefinder, the housing 20 contains a image sensor (digital camera) 25 that captures and digitizes video from the optical image through the lens 24 and contains a digital, high-resolution display 31. The video comprises a series of image frames. The computing element 16 (FIG. 3) processes the image frames, overlays each frame with various indicators, and displays the resulting image on the high-resolution display 31. Further, the high-resolution display 31 is controlled completely by the computing element 16 (FIG. 3) and need not display any of the optical image being captured; instead, the high-resolution display 31 may display setup menus, recorded video, or annotations generated by the computing element 16 (FIG. 3).

The eyepiece 22 may also be modified to accommodate viewing of the high-resolution display 31. In particular the eyepiece 22 may be inset and be protected by a shroud 35.

In contrast to the conventional rangefinder housing 20 as shown in FIGS. 14 and 15, the housing 20 of the digital rangefinder of FIGS. 17 and 18 is more compact, more lightweight, and easier to transport and use, due to removal of the end-to-end optics. For example, the length between the proximate end 28 and the distal end 26 is shown as less than about four inches. The width and height could be about two inches respectively

### AI Devices Comprising Mobile Smart Phones and Tablets

In addition to the AI advantages of the present invention, embodiments comprising mobile smart devices, such as iPhone 11 or Android (e.g., Samsung, LG, Lenovo, Amazon, etc.) have several advantages over conventional rangefinders. First, the user has one less item to carry this reduces the overall weight and complexity. Second the range finding device has a lower incremental cost to manufacture, being just the alternate housing 21 and the range sensor 12. The processor (computing element 16), tilt sensor 14, digital camera 25, high-resolution display 31, and inputs 32 (including touch screen display inputs 34) of the mobile smart device is used to provide the necessary components of the digital rangefinder device 10. Third, the mobile smart device, such as iPhone 11, has other useful features such as global positioning system (GPS), virtual maps, satellite images, emergency communications, video capture, video playback, digital photographs, etc.

Advantages of mobile smart device are explained with an exemplary scenario. The user uses the GPS and satellite images to travel to a hunting spot identified on a previous trip; however the topographical maps and satellite images allowed the user to find a more direct, shorter route. A group of targets are in thick brush. Zoom video is taken showing the details of the targets such as which are does and bucks, number of points on the antlers, size of the animals. The dynamic clear shot trajectory mode is used to identify potential obstacles and to position the user and the weapon for a clear shot. The photo is marked with the GPS coordinates and time. The photo image may be upload the deep learning training dataset. A second video is captured showing an animated projectile trajectory 2 path from a straight view (such as discussed in reference to FIGS. 28 and 29). The motion sensors of the iPhone 11 are used to determine any projectile inertia. A third video is captured showing the animated projectile trajectory 2 path from a side perspective view. The firing is aimed based on the information provided by AI device 10. When the projectile is fired, a fourth video is captured showing the actual projectile trajectory 2 and the success of failure of the shot. The success of the AI device prediction is scored. If Internet access is available via WiFi or via cellular wireless, the photo and videos can be uploaded to friends, video producers, or social networking sites, as well as deep learning training dataset. Any of the videos can be replayed.

In yet another more sophisticated embodiment of a very smart rangefinder device 10, an analysis of the second video can be compared to an analysis of the fourth video and AI device 10 can automatically recalibrate to match the true trajectory captured in the fourth video. The true parabola values, the air drag, and the crosswind drift can be determined and used for developing a training set for a future embodiment.

### Complex Harsh Natural Environments

FIG. 19 illustrates a string 40 and flexible rods 106a and 106b placed in a harsh, rough environment with hills and valleys and strong winds at different speeds and directions along the projectile trajectory path. The terrain causes different wind represented by wind 48a, 48b, and 48c. Wind 48a is illustrated going up the near hill toward the target T. Wind 48b is shown as an opposing cross wind moving right along the valley and adjacent cliff. Wind 48c is shown with a right crosswind and a slight headwind from wind coming over the taller mount crest.

The reader will see that the fiducial points 38a through 38h is a more complex curve. Such a curve may be too difficult for a human to interpret in a short enough time to make an ethical shot. However, the present invention provides the possibility of rapid accurate analysis faster than a human.

### ADVANTAGES

### Accurate

The AI device provides for accurate adjustment of aim for a given wind condition.

### Effective

Because the AI device provides for accurate adjustment of aim for a given wind condition, each shot taken will be more effective.

### Confidence

The AI wind information gives the user confidence that despite difficult wind conditions a shot can be successfully taken. This increased confidence will improve the user's performance and satisfaction.

### Increased Safety

More accurate aiming increases safety. Even in strong wind a user is assured that any object that may be impacted by the projectile will not be unknowingly harmed.

### Adjustable

The embodiments of these AI device displays are adjustable to be consistent with an individual user and associated sights, for example, distances could be presented in yards or meters.

### Lightweight

Handheld AI devices are lightweight.

### Easy to Transport and Use

AI devices easy to transport and use.

### Rapid Use

Embodiments that provide an aiming point are used rapidly without having to use brain power to select numbers and estimate an aiming point.

### Conclusion, Ramification, and Scope

Accordingly, the reader will see that the novel AI device and string provide important information regarding the projectile trajectory path and importantly provide greater accuracy, effectiveness, and safety.

While the above descriptions contain several specifics these should not be construed as limitations on the scope of the invention, but rather as examples of some of the preferred embodiments thereof. Many other variations are possible. For example, the training object could be other objects along the projective trajectory path, such as grass or trees. Further, the AI device and methods could be applied to military situations where the projectiles are fired from a cannon, tank, ship, or aircraft and where the obstacles could be moving objects such as helicopters or warfighters. Additionally, the AI device and methods could be applied to golf where in a golf mode the device would indicate crosswind corrected aiming point and which golf club would result in a ball trajectory that place the ball nearest the desired hole. The variations could be used without departing from the scope and spirit of the novel features of the present invention.

Accordingly, the scope of the invention should be determined not by the illustrated embodiments, but by the appended claims and their legal equivalents.

We claim:

1. An AI device for recognizing wind along a projectile trajectory path to a target, the AI device comprising:
a) a computing element,
b) a memory connected to the computing element,
c) at least one sensor of a group of:
i) an image sensor, and
ii) an audio sensor,
the at least one sensor connected to the computer element,
d) a display connected to the computing element,
e) a deep learning model implemented in the computing element and the memory,
wherein the sensor and deep learning model are configured to recognize the reaction of a string to wind along the projectile trajectory path,
wherein the AI device outputs wind information regarding the projectile trajectory path.

2. The AI device of claim 1,
wherein the string is the teacher.

3. The AI device of claim 1,
wherein deep learning model comprises convolutional neural networks.

4. The AI device of claim 1,
wherein during training, inputs to the deep learning model comprise:
a) wind speed and direction at a predetermined number of points along the projectile trajectory path,
b) data regarding the string.

5. The AI device of claim 4,
wherein the at least one sensor is an audio sensor,
wherein the data regarding the string is a recording of the sound made by the wind passing over the string.

6. The AI device of claim 4,
wherein the at least one sensor is an image sensor,
wherein the data regarding the string is an image showing the string along its length,
wherein the string is positioned along a segment of the projectile trajectory path,
the data, comprising one of the group of:
a) a photograph,
b) a video image,
c) a video image with audio.

7. The AI device of claim 1,
wherein wind information output by the deep learning model comprises:
a) wind speed, and
b) wind direction.

8. The AI device of claim 1,
wherein wind information output by the deep learning model comprises:
a) crosswind speed along the projectile trajectory path, and
b) headwind or tailwind speed along the projectile trajectory path.

9. A method of using the AI device of claim 4 to recognize wind along the projectile trajectory path to the target, comprising the steps of:
a) training the deep learning model,
b) placing the string on a plurality of support rods positioned along a segment of the projectile trajectory path,
c) placing AI device at the start of the projectile trajectory path where it can sense the string,
d) enabling sensing, and
e) receiving outputs regarding the recognized wind speed and direction along the projectile trajectory path.

10. A method of claim 9, further comprising the step of:
f) displaying the crosswind speed on the display.

11. A method of claim 10, further comprising the step of:
g) displaying headwind or tailwind speed on the display.

12. The AI device of claim 1,
wherein AI device further comprises a rangefinder, the rangefinder comprising:
i) crosshairs for positioning the rangefinder to range the target,
ii) an inclinometer for sensing the angle to the target, and
iii) an range sensor for determining the line of sight range to the target,
wherein the display comprises a shoot-for range indicator,
whereby the display indicates a shoot-for range adjusted for shooting angle and headwind or tailwind.

13. The AI device of claim 12, wherein the AI devices is a handheld rangefinder.

14. The AI device of claim 12, wherein the AI devices is a smart rifle scope.

15. The AI device of claim 12, wherein the AI devices is a binocular.

16. The AI device of claim 12, wherein the AI devices is a smart phone, such as an iPhone.

17. The AI device of claim 12, wherein the display illuminates an aiming point adjusted for crosswind.

18. The AI device of claim 1,
wherein AI device determines an optimum wind speed which is sustained for a repeatable period of time and illuminates a green light when that optimum wind speed is present.

19. The AI device of claim 18,
wherein AI device predicts that the optimum wind speed stable period is approaching and illuminates a yellow light.

20. The AI device of claim 1,
wherein AI device determines that the wind is unstable or extreme and illuminates a red light.

21. A system comprising:
a) the AI device of claim 3,
b) a string on a reel,
c) a plurality of flexible rod, each rod having a predetermined length, a means for holding the rod base steady against the earth, and each rod having predefined pattern of bands,
wherein the string is removably attached to a top of each rod,
wherein flex of the rod is an input,
wherein the deep leaning model detects the following:
i) location of the rod in an image, and
ii) flex of the rod,
whereby the deep leaning model more accurately recognizes winds effect on a string.
